(19) United States
(12) Patent Application Publication
(10) Pub. No.: US 2015/0193859 A1
(43) Pub. Date: Jul. 9, 2015

(54) System and method for providing delivery and other services for third party sales

(71) Applicants: Gary Michael Colello, Tyngsboro, MA (US); Dennis Michael Darcy, North Andover, MA (US); David Bruce Walek, Weston, MA (US)

(72) Inventors: Gary Michael Colello, Tyngsboro, MA (US); Dennis Michael Darcy, North Andover, MA (US); David Bruce Walek, Weston, MA (US)

(21) Appl. No.: 13/999,063

(22) Filed: Jan. 9, 2014

(51) Int. Cl. G06Q 30/06; G06Q 10/08; G06Q 30/02

(52) U.S. Cl. CPC G06Q 30/0635; G06Q 30/0222; G06Q 10/083

(57) ABSTRACT

This system and method allows e commerce retailers, at their direction or at their customer's direction, to ship their products to a brick and mortar store or other physical delivery point where the customer can pick up their purchase, offering incentives for the customer to do so.

### RELATED APPLICATIONS

The present application claims benefit of priority to provisional U.S. Application No. 61/848,787 and titled “System and method for providing delivery and other services for third party sales.”

### BACKGROUND

This invention relates to the fields of computer systems, communications and electronic commerce (“E commerce”). E commerce is one of the largest and fastest growing methods by which retailers sell products to consumers. Traditional “Brick and Mortar” stores are finding it increasingly challenging to compete with stores whose sales are exclusively or dominantly web-based. Many retailers have seen the volume of customers present in their physical stores decrease, as customers find fewer reasons to travel to physical store locations in order to evaluate, compare and purchase products. Customers enjoy shopping online, and as a result, it is becoming increasingly difficult for many traditional physical retailers to compete with the ease and convenience of shopping at home through internet-based retail sites, to offer the same wide range of products available through online retailers or to offer the same promotional incentives that can be offered by web-based retailers. Traditional “Brick and Mortar” retailers already suffer competitively from the high overhead costs of maintaining, staffing and supporting their physical retail stores, as compared to online retailers. With customer foot traffic and sales per square foot diminishing in the face of increased online sales, this competitive burden is only increasing. With the convenience of buying even their own products through a company website, it is difficult for some traditional retailers to attract customers to come and visit their stores at all. Many traditional “Brick and Mortar” retailers also have a distribution and delivery infrastructure that, for these same reasons, is currently less than fully utilized. The carrying cost of these assets is high, however, the incremental cost of utilizing these assets to service increased product flow is relatively low. It may be advantageous to the retailer with such assets to put them to increased and better use.

There is also a fierce competition among e commerce retailers. In a number of retail categories, sales are dominated by a few large retailers, who have advantages of brand recognition and scale. Very large retailers can more readily offer free shipping (sometimes tied to minimum purchase price or participation in customer affiliation programs), giving them a price advantage over smaller retailers that may otherwise have competitive prices or deeper or more specialized product offerings. Many e commerce retailers face the challenge that customers often feel more comfortable buying from larger, established brand-name retailers, which often also offer traditional “Brick and Mortar” stores where customers also may enjoy greater human interaction as well as a more enticing overall retail experience than they can obtain with a solely online retailer. Smaller online retailers are often looking for ways to distinguish themselves from the myriad of alternative web-based sellers and often confront customer uncertainty with respect to their credibility, reliability and reputation. In their efforts to distinguish themselves from their competition, they may find it beneficial to be able to offer additional customer convenience features on their websites and perhaps to align themselves in some way with well-known, brand name traditional retailers or other well-established institutions.

There is no doubt that e commerce customers enjoy the pricing advantages, extensive selection and convenience of online shopping. In many cases, the ability to arrange delivery online of these purchases is an additional convenience. That convenience, however, has its limitations. The most obvious limitation may be shipping costs, which can outweigh the underlying pricing and other advantages of online purchases, particularly when purchases are made from smaller online retailers who find it difficult to absorb the cost of free or discounted shipping. In addition to cost issues, customers and others have become increasingly concerned about the security of at-home delivery, particularly as online sales of high-value/high-risk products have grown. Few e commerce customers are regularly at home to receive deliveries in person. Customers, both urban and suburban, have begun to worry about the safety of high-value purchases being left unattended in delivery locations susceptible to theft, vandalism, weather damage and personal safety and privacy issues. If deliveries are not left on the doorstep, as is often the case with certain computer, electronic and other high value items, a trip to the delivery service distribution center is often necessary. This is seldom a convenient, pleasant or otherwise beneficial undertaking. These concerns are only magnified with respect to customers who are frequently away from home for business or personal reasons, live in apartments or other multiparty living arrangements, or have vacation homes or other home accessibility issues.

For any of these reasons, e commerce customers may, either regularly or from time to time, prefer that deliveries not be made at home, but instead at other convenient or otherwise attractive locations. In many cases, delivery at a physical retail location or other convenient or enjoyable delivery location may be preferable. Customers do not abandon or necessarily dislike the traditional physical retail shopping experience, simply because they make online purchases. They frequently enjoy, or rely upon, both. Even if they have ordered a product online, they may have other ancillary purchases they would be inclined to make in a retail store if that is where they are picking up their online purchase, for example, office supplies in connection with the purchase of a computer or printer or DVDs, CDs, games or other content in connection with the pick-up of an electronic device ordered online. This inclination would be strengthened with intelligently designed and focused incentive programs. The trip to pick up online purchases may also be the trigger for other unrelated planned, unplanned or impulse purchases to occur, and incentives may again be offered to stimulate such sales and in fact to encourage use of the retail store delivery option. Package pick-ups at coffee shops and other community-based locations may offer social opportunities as well.

### DESCRIPTION

This invention allows e commerce retailers, at their own direction or at their customer's direction, to ship their products to a brick and mortar store or other physical delivery point where the customer can pick up the purchase. In one embodiment of the invention, this feature would be made available on the e commerce retailer's web-based storefront, where there would be an option (described in more detail below) that would allow its customers to elect delivery of the purchased product at one or more physical locations, instead of, or as an alternative to, traditional home or office delivery. Such physical locations could, among others, include traditional retail stores, coffee shops and other food service locations, stand-alone pick-up locations (including free-standing and mall and other shopping center-based locations), warehouse stores, grocery stores, traditional package delivery locations (for example, UPS, FedExp, USPO), community centers, educational or religious locations, etc.

In one embodiment of the invention, the system and method for enabling the foregoing would be software resident on system servers. These system servers would communicate with the servers or other computer systems serving e commerce retailers, delivery locations and delivery service providers to provide and enable the desired delivery choices and locations. The system servers would also provide for those choices and other parameters to appear on the e commerce retailer's online storefront and be accessible to its customers through the purchase, delivery and check-out process or otherwise. In another embodiment of the invention, customers would be permitted to select among a range of shipping and delivery methods and locations. In another embodiment of the invention, those selections might vary or be limited depending upon the nature of the product being purchased and/or other factors, such as the physical location of the customer. In another embodiment of the invention, the e commerce customer may register for the service offered by the invention and in doing so, specify the customer's preferred delivery locations and other delivery or related preferences and parameters. These parameters and or preferences could be changed from time to time by the customer or varied, depending upon the nature of the purchase, or the third-party, if any, such as family members, for whom the purchase is being made. In another possible embodiment of the invention, the invention could provide for an e commerce retailer and one or more delivery location providers to enter into arrangements that provide for exclusive, preferential or other product-specific or product-category delivery locations.

In one embodiment of the invention, e commerce customers, as well as e commerce retailers, would be provided with online product delivery tracking features enabling customers to access, or be informed of, the delivery timeline and status of their purchase. In one embodiment of the invention, this feature could be used by the e commerce retailer and/or delivery location provider to communicate with the customer with regard to promotional, marketing or other matters. An embodiment of the invention might also include the ability to process product returns through the same delivery location at which the product was received. This could represent a major convenience to the customer, who otherwise must undertake a considerably less convenient interaction with the online retailer and shipping service providers to successfully complete a product return.

In one embodiment of the invention, an e commerce retailer would be able to drop products for delivery to customers at one store of a retail chain for delivery to another store in the same retail chain where the item would then be available to pick up by the customer. This provides two episodes of in-store traffic for the retail chain, one by the online retailer and the other by the e commerce purchaser. Delivery of the package between stores could be carried out at low cost using the retail chain's existing shipping and distribution infrastructure. The store could even deliver it to the customer's house or residence.

In another embodiment of the invention, a single retailer or a separate storefront (collectively, the “mall pick up location”) may be established as the collection point for all of a customer's purchases at a shopping mall or can be designated by an e commerce customer as a designated, preferred or exclusive delivery point for certain or all of that customer's online purchases. In addition to online and mall purchase pick up services, the mall pick up location may also offer other services, including pick up of all the customer's purchases at the mall, gift wrapping and outgoing shipping services, warranty services, return services, delivery of purchases to the customer's automobile or home, valet, concierge and other services. Customers could be given a plastic card, smart phone application or other device that the customer would use while shopping to identify the customer and his or her purchases and other information. The mall pick up location could also offer discount coupons, special promotions and other incentives or convenience features involving one or more or all stores in the mall as an additional customer benefit and inducement to use the service. The services of the mall pick up location could be provided on a no-cost basis to customers or on a fee or membership basis. These service fees could be based upon fees for individual services, membership fees, or fee or rebate arrangements linked to customer behavior, such as individual or cumulative purchases.

In addition to those noted above, the invention may include one or more embodiments offering incentive and promotional arrangements offered by the e commerce retailer, the delivery location provider or other third parties designed to encourage utilization of the invention by retail customers. These could include incentives that can save customers money on other purchases in the physical store or other location that serves as pick up location, or for future online or in-store purchases from that retailer or from other retailers. Incentives can be coupons or limited time sales promotions on other items and may even be targeted at items compatible with, ancillary to or otherwise related to the items purchased on line. (Some examples of compatible items could be headphones for MP3 players, batteries for hand held electronics, covers for tablets, movies for DVD players.) The “Brick and Mortar” store may also offer technical advice such as set up and installation for items bought on line. It can also provide for the return of the item as well as warranty service or offer a warranty to cover the item for damage or loss. Incentives might also include discounts or other promotions for other items, such as coffee shop or other food purchases or community support endeavors, such as fund raising. Such promotions could be marketed and advertised by the e commerce retailer, the delivery pick location provider or other parties and made known to customers as part of the online purchase and delivery experience, but could also be available at the pick-up location. Promotions will change from time to time. Availability and use of these incentives and promotions could, in any event, be tied to and conditional upon actual pick up of the product at the designated delivery location.

The “Brick and Mortar” store and ecommerce retailer can share web sites with this shipping arrangement. In some cases the consumer may find a similar item at the “Brick and Mortar” store in which case the consumer is offered the option to purchase the similar item instead. When the customer accepts the similar item from the Brick and Mortar store the e commerce seller is paid a commission by the Brick and Mortar store. If it is exactly the same item that the Brick and Mortar store (or its affiliated online storefront) sells, the Brick and Mortar store may offer to sell the item directly and pay a commission to the e commerce seller. This can be seamless so that the buyer may be unaware.

In one embodiment of the invention, one or more retailers with multiple traditional “Brick and Mortar” retail and/or service locations could, using an embodiment of the invention, enter into exclusive or non-exclusive arrangements with one or more online sellers to provide for delivery locations for all or certain categories of purchases, for example, all electronic products or all automotive parts and accessories.

In another embodiment of the invention, retail customers could be offered the opportunity to register with or join as members or otherwise a service offering utilizing an embodiment of the invention to provide for the use of delivery locations other than their residence for some or all of their online purchases in one or more retail categories. Such service offering could provide for incentives of the nature described elsewhere herein and/or membership or other incentives and benefits based upon frequency and/or level of use of the service.

All references in this provisional patent application to e commerce, online, web-based or other sellers or retailers shall also be deemed to refer to any seller or retailer as to which television or radio (whether broadcast, cable, satellite, wireless, internet or other), telephone (whether traditional, cellular, satellite, internet or other), printed catalog, direct mail, newspaper, magazine, physical display, personal solicitation or other media or method of communication, interchange or commerce is the principal or a significant source or actual or potential revenue, inasmuch as one or more embodiments of the invention may be employed to address and apply thereto.

### BRIEF DESCRIPTION OF THE DRAWINGS

A more complete understanding of the invention may be obtained by reference to the drawings, in which:

FIG. 1 shows a typical shopping scenario.

FIG. 2 shows the flowchart illustrating one possible ShipPal process.

FIG. 3 shows an example of a customer buying a fishing rod.

FIG. 4 shows a customer login process.

FIG. 5 shows a customer filling in billing information.

FIG. 6 shows a customer entering shipping information.

FIG. 7 shows the customer being presented shipping options.

FIG. 8 shows a customer being presented a map with pickup locations.

FIG. 9 shows a customer being offered incentives for using ShipPal.

FIG. 10 shows an order confirmation of pick up person.

FIG. 11 shows a review of a customer's order.

FIG. 12 shows an example of a consumer making a purchase online from the seller's perspective.

FIG. 13 shows an example of a consumer making a purchase online from the ShipPal store's perspective.

### DETAILED DESCRIPTION

Set forth below are descriptions of examples of the manner in which one or more embodiments of the invention may appear and function:

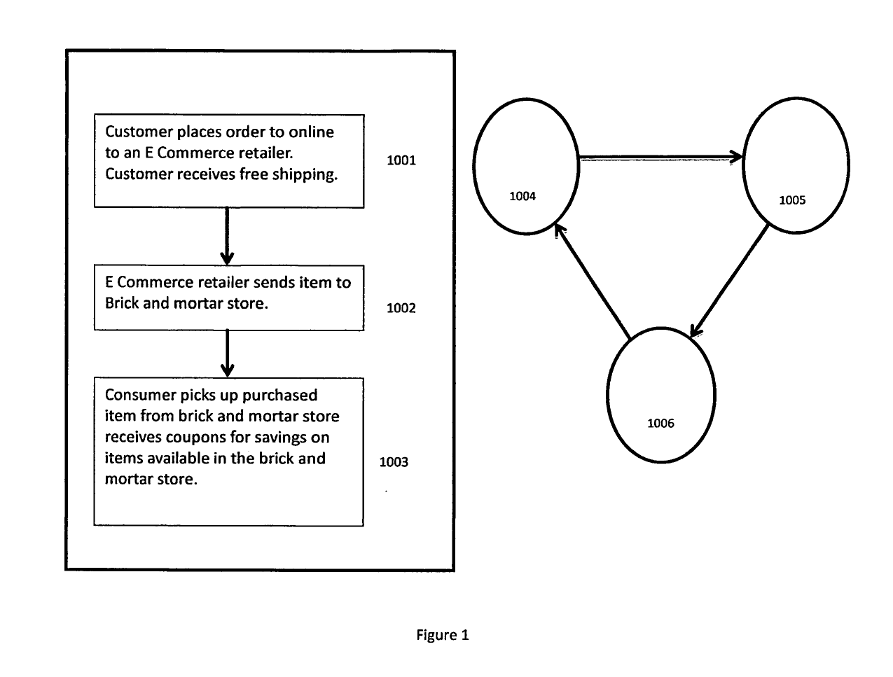

In a typical shopping scenario (illustrated in FIG. 1), an e commerce customer buys an item on line by placing an item or items in the customer's online shopping cart. When finished shopping, the customer proceeds to checkout. There they are asked to select shipping options. They enter their zip code and are presented with a list of options, each having the cost to the customer of each option displayed. One option is called ShipPal. (ShipPal is a name being used herein solely for illustrative purposes) The customer selecting the ShipPal option will enter ultimate destination of their purchase. The customer is then presented a map showing various pick up points in a radius around their desired destination along with their associated shipping costs (if any) and other options such as two day delivery, same day delivery, three to five day delivery cost for each possible delivery location. The lowest cost option may also be displayed. Also for each pickup point, the system will show the incentives, if any, available for each such delivery location, such as shopping coupons. Incentives may include discount coupons, cash cards, rebates, reward points or other incentives or rewards, and may be time-limited, and may be applicable only to transactions conducted at the delivery location, at nearby retail outlets, for other online purchases or otherwise. Incentives and other rewards may be linked to the method, timing and cost of the delivery option selected. Not every delivery location will accept every item for delivery. There will be agreements on the type of items that are acceptable and filters built in to the software that will direct acceptable items to appropriate ShipPal locations.

Customers may also preregister, or enroll as a member, with ShipPal, or other provision may be made, so that key data for the customer is stored. Key data may include name, address, payment methods, delivery preferences and other consumer data such as a brand name preference, and other information. This data may be used in selecting the incentives and possible delivery locations. Customer location, shipping preferences, preferred delivery locations and other information may also be entered automatically by the customer's smartphone, laptop, tablet or other PDA or electronic device. This customer data may also be available for use for other commercial purposes, including targeted advertising and promotional programs.

Shipping may be paid by the customer, the e commerce retailer, the “Brick and Mortar” store. Advertising or other revenue generated on the ShipPal or other web site where shipping method was selected may also be used to offset in whole or in part for the shipping costs, either on an individual basis or an aggregate of many transactions. There can also be revenue generated by the retailers whose coupons are distributed. The retailer may offer warranty services for the product purchased online and the revenue from that transaction will offset the cost of shipping. The best case scenario is one where the customer does not pay for shipping.

As noted above, there may be a series of shipping methods and delivery times and locations, as well as a list of incentives that will be associated with the choice of a particular delivery option and/or method and time of delivery, such as overnight, one-day, two-day, three-day and other delivery options. Longer delivery times may be associated with lower costs or increased incentives, or both. The number of delivery location choices may be set on the basis of a radius surrounding the customer's location. Such radius may be selectable by the customer, with a default radius appearing initially or used in the event the customer does not make an alternative selection.

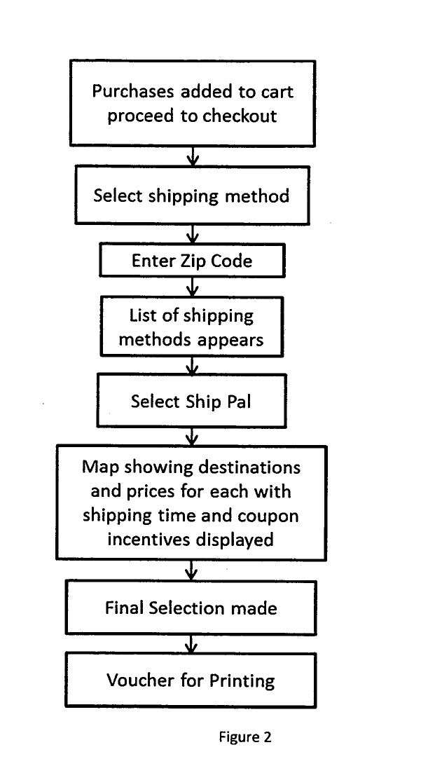

There may also be occasions where the customer may pick up the package in a state other than the state in which the customer resides or the e commerce retailer is domiciled. A transaction flow and a diagram showing the relationship between the parties engaging in the transaction are shown in FIG. 2. FIG. 2 shows the flow of a transaction where a customer places an order 1001, the item purchased is then sent from the e commerce retailer to a “Brick and Mortar” store, 1002 and the customer picks up his or her e commerce purchase at the “Brick and Mortar” store and receives coupons and or other incentives from the “Brick and Mortar” store 1003. The participants are then the e commerce retailer shown as 1004, the “Brick and Mortar” store shown as 1005 and the customer shown as 1006. The item purchased is shipped to the “Brick and Mortar” store. Shipping can be carried out in a variety of ways and the “Brick and Mortar” store may be part of a network of stores or may be a stand-alone (free-standing, mall-based or other) delivery location.

The consumer selects their delivery location and may print out a voucher that they will use at the delivery location to retrieve their parcel along with the coupons or other incentives. The consumer may elect to receive their voucher via email or text to their smart phone or through other electronic or other methods.

Upon notification, which may be transmitted by email, text, telephone or any other manner, of availability for pick-up of the item, the customer has a period of time in order to pick it up. Customers may be given the option to lengthen or otherwise specify that period of time, for convenience purposes. Customers would receive one or more reminders of availability for pick up. Failure to pick up the item would force the shipment to go to a default address, which could be the customer's home address or an alternative pick-up location, and in such event, the cost of shipping may be charged to the customer.

The following is a series of steps that also describe the preceding transaction:

1. Complete purchase select shipping method

2. Enter zip code display shipping prices

3. Possible shipping methods:
a. UPS $
b. FedEx $
c. USPS $
d. Ship Pal $ (minimum)
   i. Enter home address or allow computer or smart phone to uses
   ii. Select from a map of options showing shipping costs and showing coupon value or offer
   iii. Also shows shipping time and coupons received
      1. A two day shipping may have less incentive than a 3 to 5 day shipping time
      2. There is a time limit on redeeming coupons.
   iv. Set radius by first # closest options
   v. Set radius by pre-set-radius
   vi. User selectable radius
   vii. Select from a list of pickup points
   viii. Or enter a radius you are willing to travel to get your package
   ix. User selects location
      1. Prints out shipping voucher
         a. User selectable coupon different coupons or deals available at a particular store
         b. Or choose at store their own special deal
      2. Coupons printed on voucher
      3. Send to smart phone for coupons and voucher
   x. Pick up purchase at store
      1. Sent to particular counter in store (walk through store)
      2. Pickup counter may be determined by item purchased
         a. Buy mp3 player forced to walk though music or electronics accessories

4. Pick up store

5. If they don't pick it up at the store
a. Repeated warnings, email text, . . .
b. Forward to home address where the consumer pays for the shipping

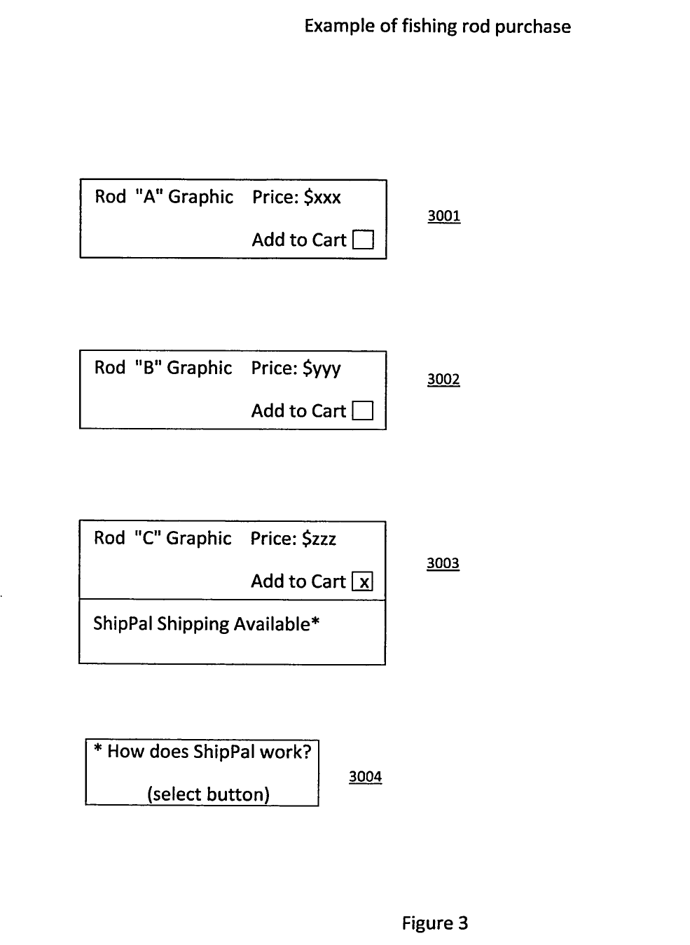

FIG. 3 shows an example of a customer buying a fishing rod. He is offered three different options Rod A or 3001, Rod B or 3002, and Rod C or 3003. Rod A and Rod B are not available for ShipPal however Rod C has ShipPal available. There is also an opportunity for the user to click a link, 3004, and learn about ShipPal. Clicking that option 3004 will bring the user to a screen that explains ShipPal and will offer to let the user join and preload all of their shipping information. In this example the customer clicks Rod C and moves on to the checkout option.

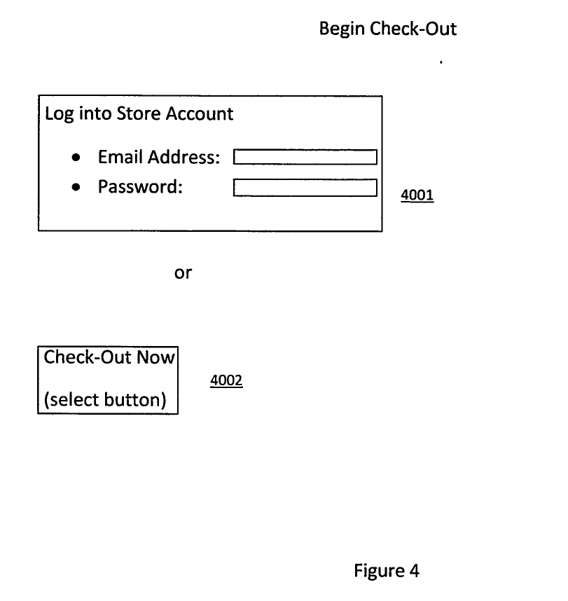

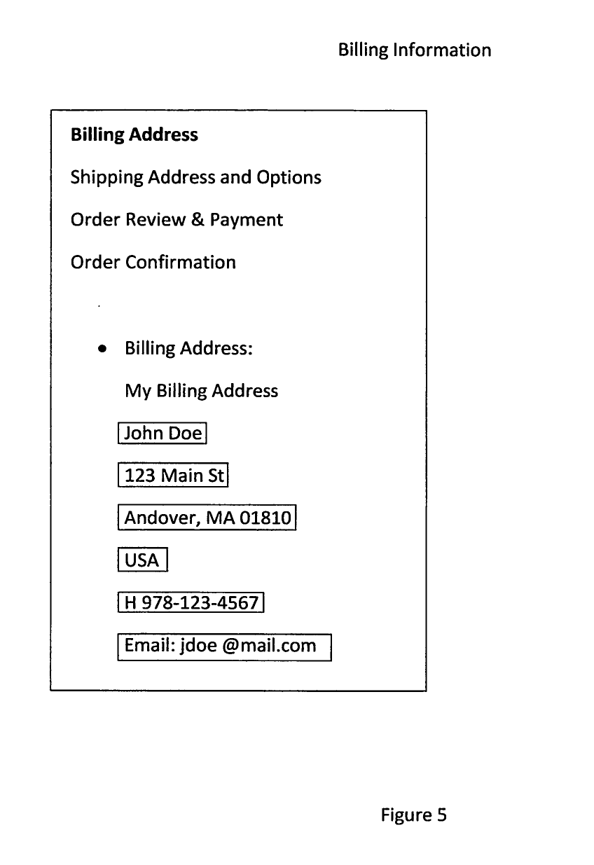

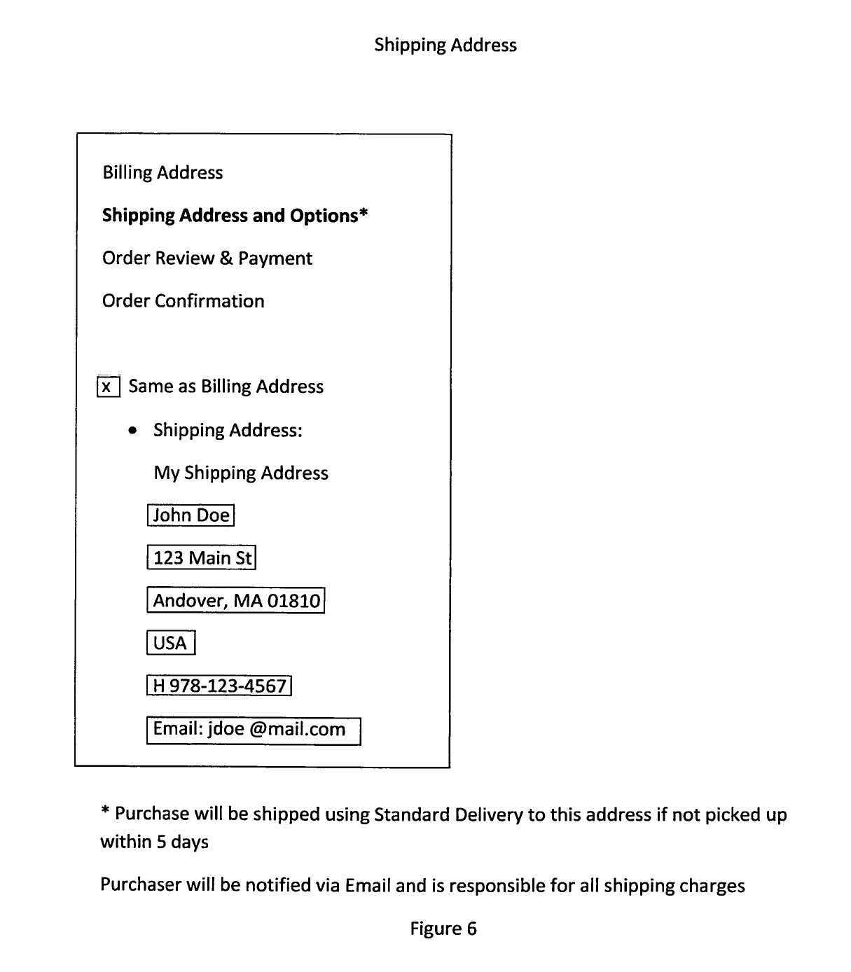

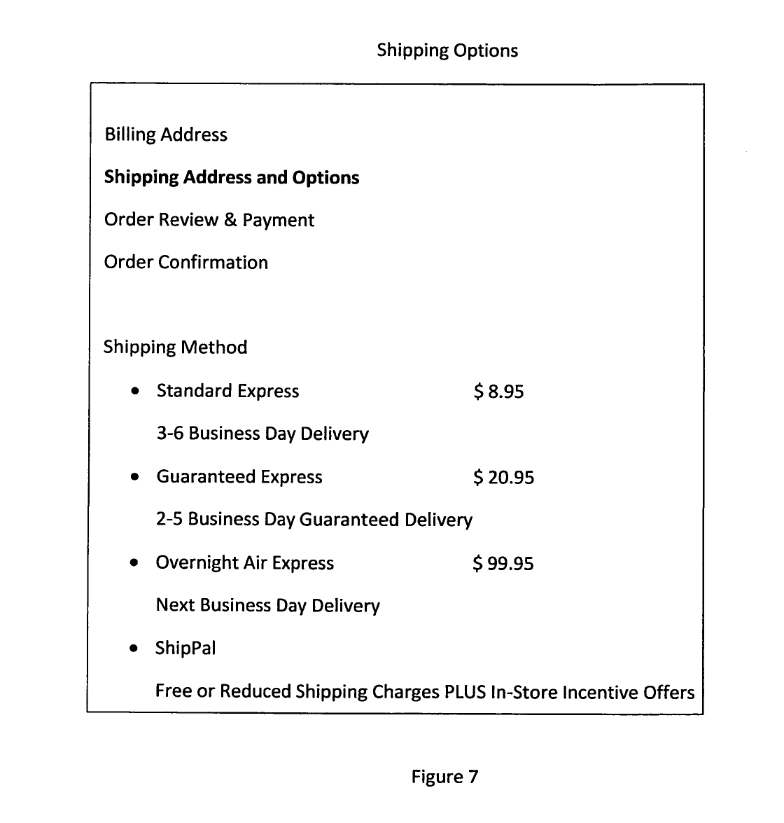

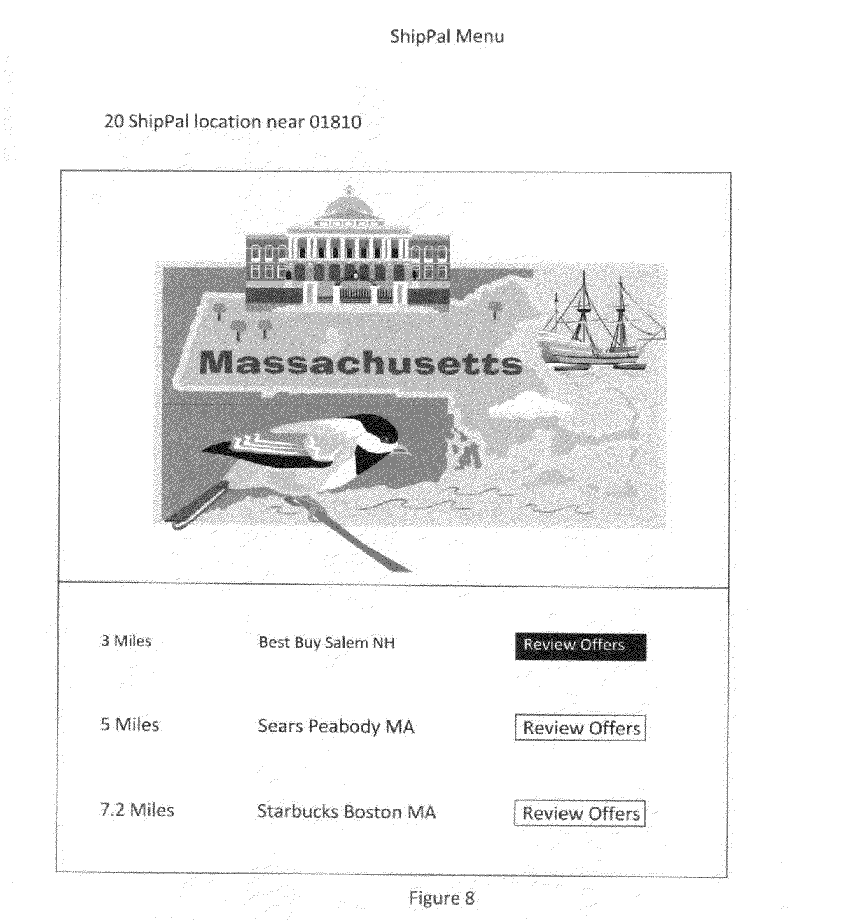

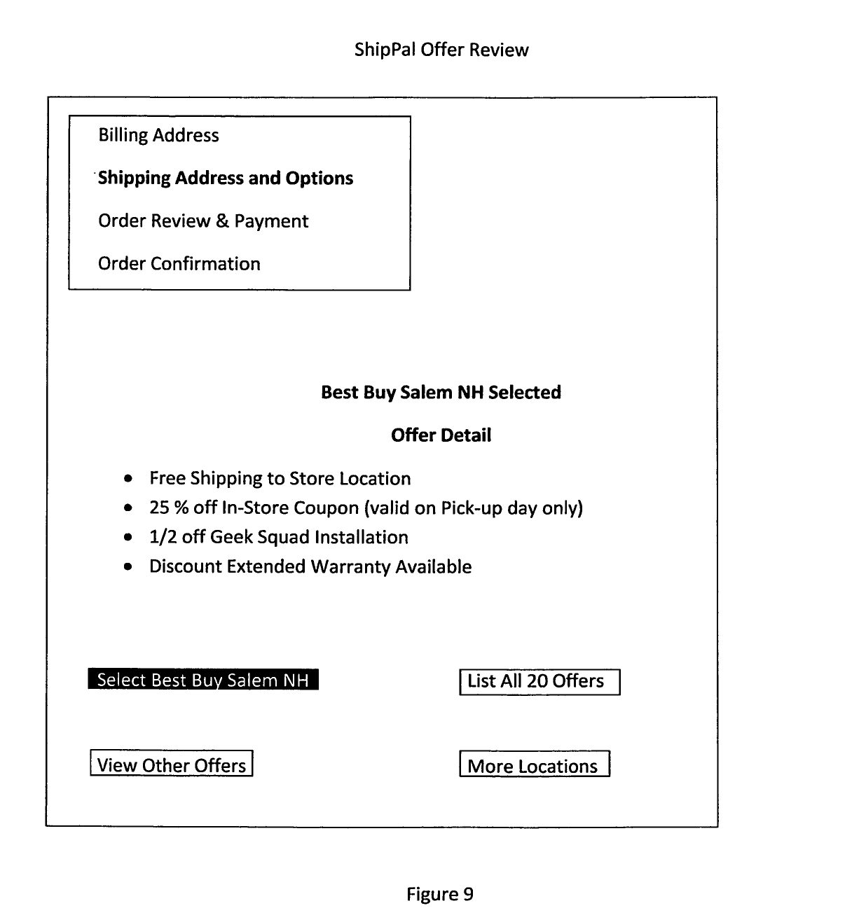

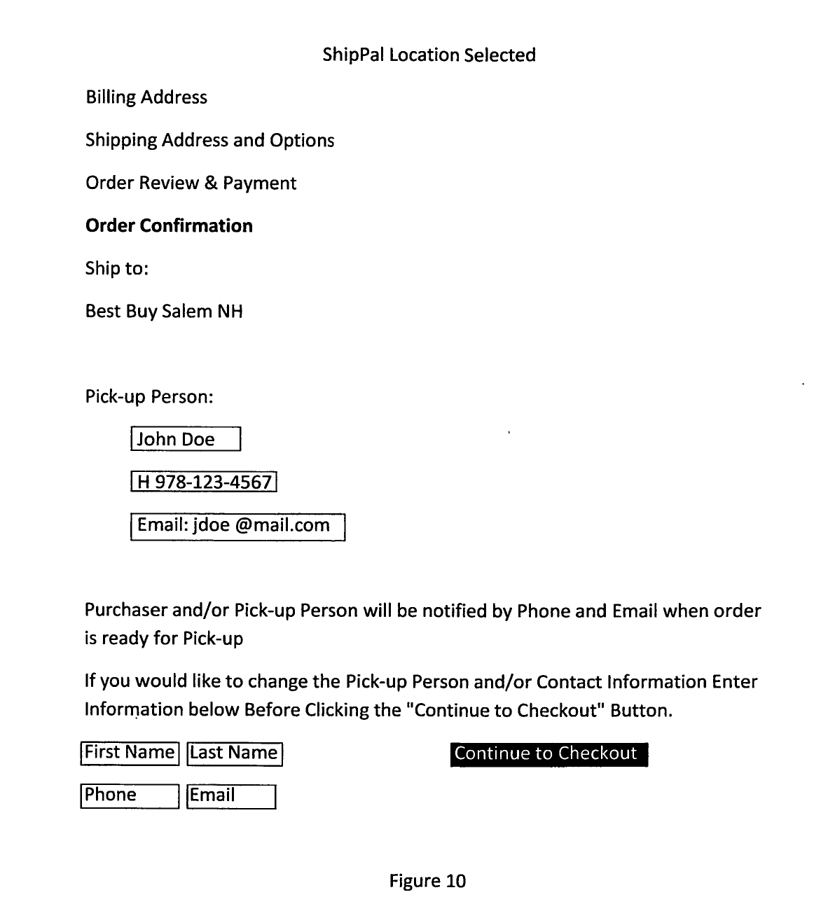

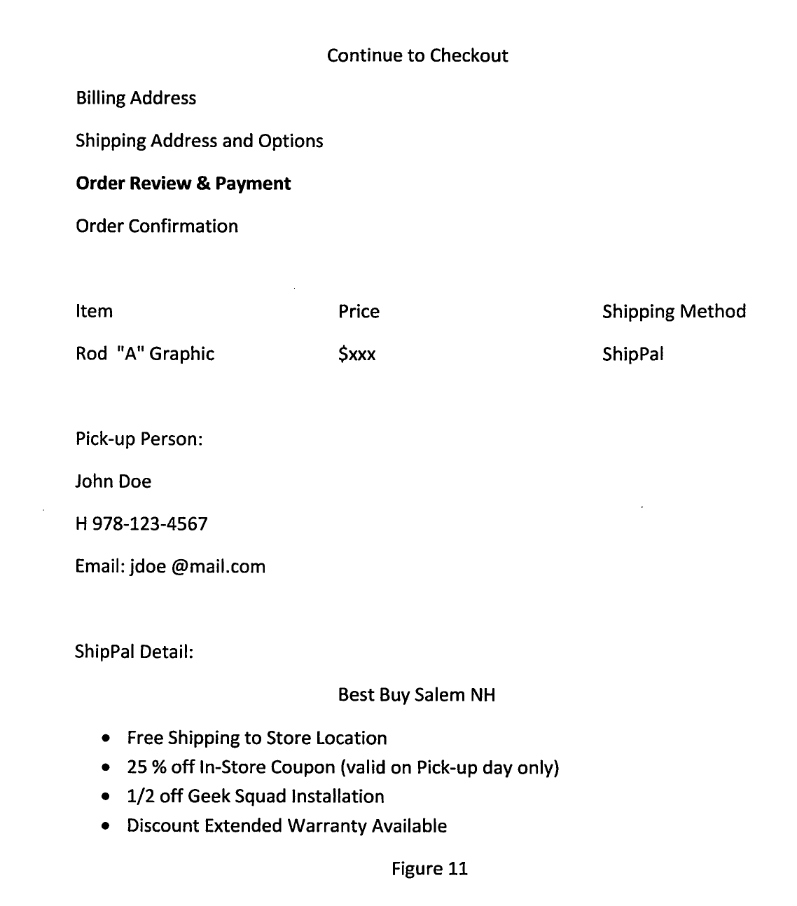

The next option is shown in FIG. 4 where the customer is offered to enter his or her login information to a store account 4001, or to check out now 4002 which will bring the customer to the checkout without loading their prior supplied information. FIG. 5 shows the next step in the purchase process where the customer enters his or her billing address and may also be pre-entered if the user had logged on the their store account. It also has links that show where the customer is in the process. In FIG. 5 the customer is entering their Billing Address so that line is in Bold. The next step is Shipping Address and options which will be shown in FIG. 6. FIG. 6 shows the user entering their shipping address. They may check the box to use the billing address which will automatically fill in the billing address into the shipping address. If logged in to their ShipPal account this section may already be filled in. This page also includes a warning to the user that if their package is not picked up in 5 days, the package will be shipped to their home using standard delivery and the customer will be billed for the cost of shipping. FIG. 7 shows the shipping options presented to the customer. It shows four different shipping methods. First it shows standard Express, which is the standard shipping method used by the retailer. Many times this is the United States Postal Service. The second method in this example is called Guaranteed Express which is a 2 to 5 business day guaranteed shipping. The Third is overnight Air Express which is a guaranteed overnight shipper. Finally it shows ShipPal, which offers free or reduced shipping costs along with in store incentives. Selecting the ShipPal option brings us to the next web page shown in FIG. 8. FIG. 8 shows a map of Massachusetts where the customer lives in this example. Below the map shown in the figure are the top 3 choices. The user in this case has selected to review the offers for Best Buy in Salem N.H. that is only 3 miles away from the customer's home. Selecting that option brings us to the next page or FIG. 9. FIG. 9 shows the ShipPal reviewed selected in FIG. 8. The current page is in bold at the top of the page, Shipping address and options. FIG. 9 shows the incentives for having the item shipped to Best Buy in Salem N.H. It shows the offer detail as free shipping to the store, a 25% off sale for purchases made in that store for the day the shipped item is picked up, it also offers half off any Geek Squad installation for the item shipped there as well as offering a discount on the extended Warranty for the item shipped there also. In this example the customer selects the Best Buy Salem N.H. which is shown as white lettering on black background to show it in fact was selected. This brings us to the next web page shown in FIG. 10. In FIG. 10, the user has advanced to the Order Confirmation page shown in bold text. It also confirms that the purchase is being sent to the Best Buy in Salem N.H. It shows that the purchase will be picked up by the customer John Doe with Mr. Doe's emails. However it allows the Purchaser to select someone else to pick up the unit by entering their name and email address at the bottom of the page. The user then selects continue to checkout which the user has done at the bottom of the page shown in FIG. 10. This advances the purchaser to the next web page shown in FIG. 11. FIG. 11 shows a review of the customer's order. It shows the item being purchased, the pickup person's name, phone number and email address, and it shows the ShipPal Detail. The customer then goes to the final checkout page where they pay for their purchase.

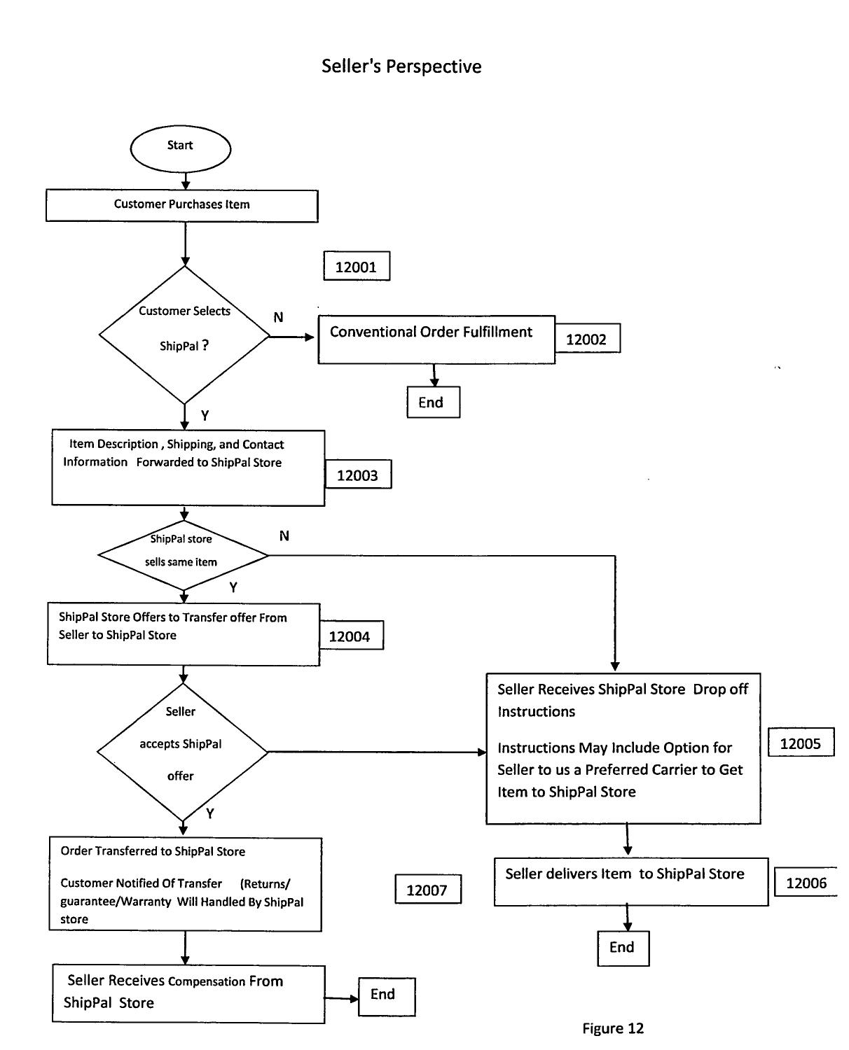

FIG. 12 shows an example of a consumer making a purchase online from the seller's perspective. The Customer purchases an item 12001. They then decide whether to use ShipPal if not the sale proceeds as if it were any conventional sale 12002. If however the purchaser selects ShipPal then a description of the item along with shipping and contact information are forwarded to the ShipPal store. The ShipPal store is the store used for package pickup 12003. If the ShipPal store has the same item or even a similar item the ShipPal store then offers to transfer the sale from seller to the ShipPal store 12004. The ShipPal store makes that offer to the seller. If the offer is not accepted or if a similar or the same item is not sold by the ShipPal store the seller receives the ShipPal Store drop off instructions 12005. If the ShipPal store does not have the same or similar item The seller delivers item to ShipPal store 12006. If the seller does accept the ShipPal offer then the order it transferred to the ShipPal store and the Customer is notified of the transfer. Returns, a guarantee or warranty will then be handled by the ShipPal store 12007. The seller then receives compensation from the ShipPal store 12008.

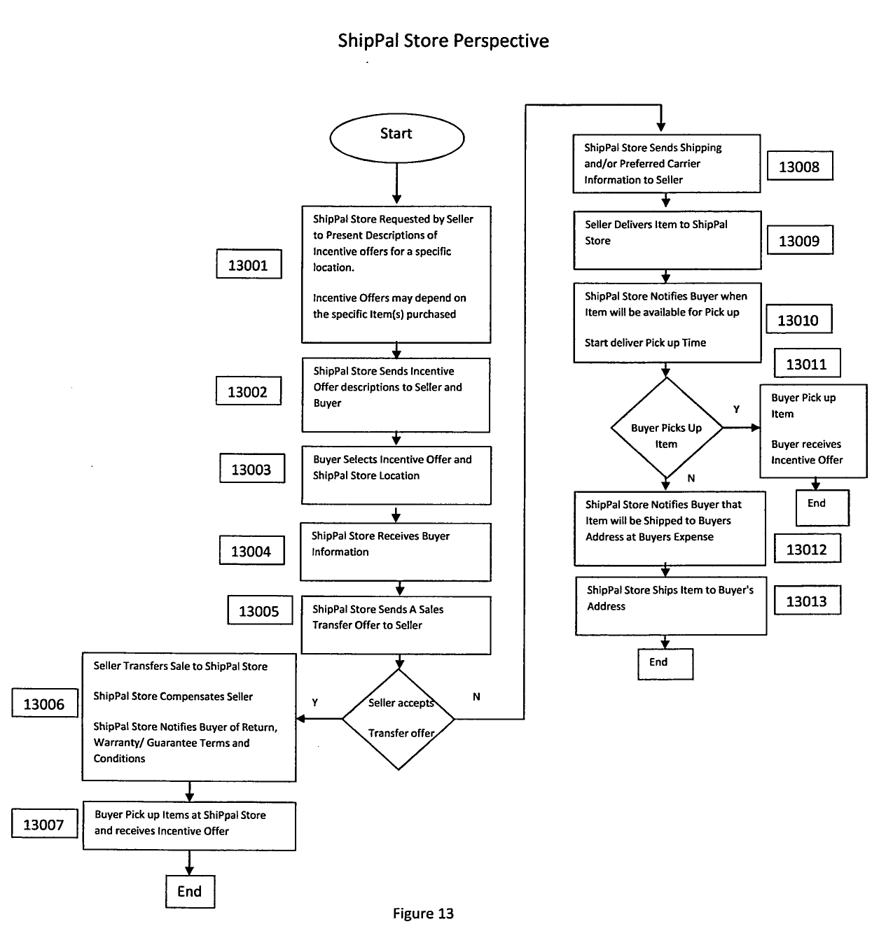

FIG. 13 shows a transaction from the point of view of the ShipPal store. The ShipPal store receives a request from the seller to present incentives offers for s specific location. The seller may also forward a description of what is being purchased as well as information about the purchaser so that the incentive from the ShipPal store may be tailored for that item and or that customer 13001. The Incentive offer descriptions are sent to the seller 13002. The buyer selects the incentive offer and the ShipPal store location 13003. The ShipPal store receives the Buyers information 13004. The ShipPal store sends a sales transfer offer to seller 13005. If the seller agrees the seller then transfers the sale to the ShipPal store, The ShipPal store compensates the seller, and The ShipPal store notifies the buyer of Return, warranty/Guarantee Terms and conditions 13006. The buyer picks up the purchase at the ShipPal store and receives the incentive offer 13007. If the seller does not accept the sale transfer then the ShipPal store sends shipping and or preferred carrier information to seller 13008. Preferred carrier may be the shipping company of choice for the ShipPal store or it may be part of the ShipPal store's shipping infrastructure such as their own trucks 13008. The seller then delivers the item to the ShipPal store 13009. The ShipPal store notifies the buyer that their item is ready for pickup 13010. If the buyer picks up his purchase, the store gives the buyer its incentive offer 13011. If the buyer does not pick up its item the ShipPal store notifies the buyer that the item will be shipping to the buyers address at the buyer's expense 13012. The ShipPal store ships the item to the Buyers address 13013.

It is intended that all matter contained in the above description or shown in the accompanying drawings be interpreted as illustrative rather than in a limiting sense.

What is claimed is:

1. A method of business whereby an e commerce retailer sells a product to a customer and is transferred to a third party retailer for customer pickup or delivery, and at least one party to the transaction receives an incentive.

2. The method of claim 1 wherein the transaction takes place over the internet.

3. The method of claim 1 wherein the transaction takes place by way of a telephone conversation.
